(19) United States
(12) Patent Application Publication
(10) Pub. No.: US 2005/0285293 A1
(43) Pub. Date: Dec. 29, 2005

(54) Synthetic textured thatch elements for building construction and methods of making the same

(76) Inventors: James Michael Brown, East Middlebury, VT (US); Dennis Allen Rotax, Lincoln, VT (US); Richard Robert Soelch, Essex Junction, VT (US)

Correspondence Address: TESTA, HURWITZ & THIBEAULT, LLP, HIGH STREET TOWER, 125 HIGH STREET, BOSTON, MA, 02110, US

(21) Appl. No.: 10/878,910

(22) Filed: Jun. 28, 2004

(51) Int. Cl. B32B 3/00

(52) U.S. Cl. 264/51; 428/156; 264/138

(57) ABSTRACT

The present invention provides a synthetic thatch element for building construction including an elongate polymer strip with one or more texture elements on at least one surface to provide a natural appearance. Thatch elements according to the invention can be incorporated into thatch element constructions for use in building construction. The present invention also provides methods for producing textured thatch elements.

### FIELD OF THE INVENTION

The present invention relates generally to synthetic thatch elements, and more particularly to synthetic thatch elements for use in building construction.

### BACKGROUND

Thatch elements are often used as decorative or building materials. Natural thatch elements, however, tend to be flammable and are degraded rapidly by natural elements, such as sunlight, heat, water, molds and fungi. Synthetic thatch elements made from polymers or other materials can be designed to have increased environmental stability. However, existing synthetic thatch elements have smooth, regular surfaces that look unnatural. There is, therefore, a need for durable, synthetic thatch elements that have a natural appearance when used as decorative or building materials.

### SUMMARY OF THE INVENTION

It has been discovered that a synthetic thatch element which has a natural appearance can be efficiently and economically produced for subsequent use in building construction. The thatch element includes an elongate polymer strip having first and second surfaces, wherein at least one of the surfaces includes a texture element. The texture element can be regular or irregular. The thatch element can have at least one end that tapers to a point. The polymer strip can be a foamed polymer, and it can contain particulate fillers and/or a second polymer. At least one of the surfaces of the thatch element can be embossed or abraded.

The present invention also provides methods for producing a thatch element for building construction as discussed herein. One method includes the steps of forming a molten polymer into an elongate polymer strip having first and second surfaces, and texturizing at least one of the surfaces. In some embodiments, the polymer is foamed. In other embodiments, the polymer is embossed or abraded. The polymer strip can be formed by molding or extrusion. An extruded polymer strip can be cut to produce at least one tapered end.

Another method for producing a thatch element according to the invention includes the steps of adding a blowing agent to a molten polymer and forming the polymer into an elongate polymer strip. The blowing agent can be a chemical foaming agent or a gas. The polymer strip can be formed by molding or extrusion. An extruded polymer strip can be cut to produce at least one tapered end.

### BRIEF DESCRIPTION OF THE DRAWINGS

The invention is pointed out with particularity in the appended claims. The advantages of the invention can be better understood by reference to the description taken in conjunction with the accompanying drawings.

The drawings are not necessarily to scale, emphasis instead generally being placed upon illustrating the principles of the invention. In the drawings, like reference characters generally refer to the same parts throughout the different views.

FIG. 1 is a schematic top view of an embodiment of a thatch element containing irregular texture elements and a tapered end.

FIG. 2a is a schematic top view of an embodiment of a thatch element containing a regular texture element and a tapered end.

FIG. 2b is a schematic, cross-sectional end view of the thatch element of FIG. 2a.

FIG. 3 is a schematic, cross-sectional end view of an embodiment of a thatch element containing multiple regular texture elements.

FIG. 4 is a schematic, cross-sectional end view of another embodiment of a thatch element containing multiple regular texture elements.

FIG. 5 is a schematic top view of an embodiment of a thatch element construction made from thatch elements containing regular and irregular texture elements and tapered ends.

### DETAILED DESCRIPTION OF THE INVENTION

The invention provides a synthetic thatch element for building construction that has a natural appearance. Specifically, the thatch element contains one or more texture elements on at least one surface. Thatch elements according to the invention can be incorporated into thatch element constructions for use in building construction. The invention also provides methods for producing textured thatch elements.

Throughout the description, where compositions are described as having, including, or comprising specific components, or where processes are described as having, including, or comprising specific steps, it is contemplated that compositions of the invention also consist essentially of, or consist of, the recited components, and that the processes of the invention also consist essentially of, or consist of, the recited steps.

Synthetic Textured Thatch Element

Any polymer or mixture of polymers known in the art may be used to prepare the thatch elements. Examples of suitable polymers include polyolefins, polyvinyl chloride, polyesters, polycarbonates, polyamides, ethylene copolymers, polyphenylene oxide, polystyrenes, and polyacrylates. When a mixture of two or more polymers forms the thatch element, the polymers may be mixed in the molten state before forming the thatch element, for example, in an extruder or a batch polymer mixer. Alternatively, the polymers may be mixed as the thatch element is formed either inside of a die, for example, in a multi-layer sheet-like extrusion die, or outside of a die, for example, by adhering individual layers together in a laminate-like structure.

The thatch elements may contain one or more other ingredients typically added to polymers to achieve specific properties. The ingredients include, but are not limited to, plasticizers; process aids; flame retardant additives; stabilizers, such as UV light stabilizers; colorants, such as pigments and dyes; fillers; clays; minerals; glass beads; foaming agents; reinforcements; impact modifiers; and other polymers.

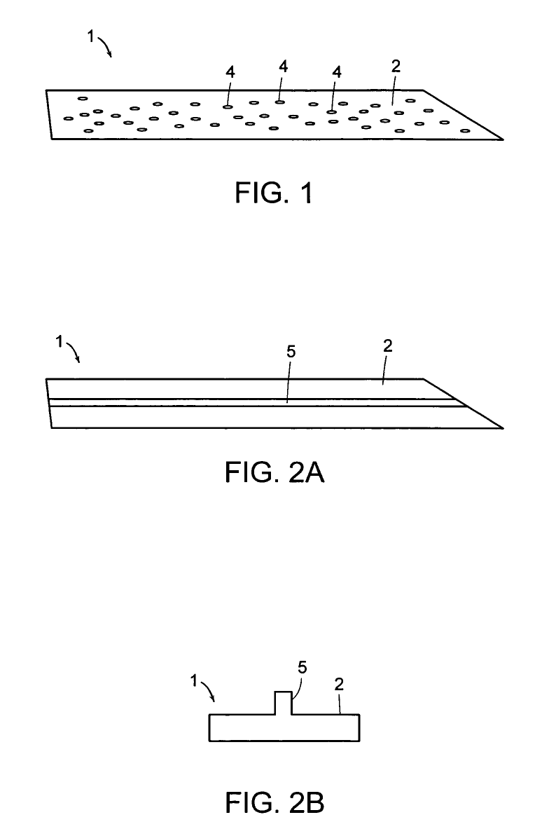

The thatch elements can be manufactured in a variety of shapes. Preferred shapes are those that are similar to natural thatch. For example, a thatch element can be in the form of an elongate, flat strip, similar to grass or palm leaves, as illustrated by FIGS. 1-3, or the thatch element can have a round or oval cross-section, similar in shape to a reed. Other shapes that are not similar to natural thatch are also contemplated by the present invention. Such shapes include cross-sectional end views that have an “X”, “+”, “T”, “H”, “*”, triangular, square, rectangular, quadrilateral, or serpentine shape. A exemplary unnatural thatch shape is illustrated in FIG. 4. A thatch element can be manufactured in any shape known to those skilled in the art of polymer molding and/or extrusion.

In some embodiments, a thatch element is solid. In other embodiments, the thatch element can be hollow or otherwise contain one or more internal cavities.

Thatch elements can be manufactured in a variety of sizes and dimensions. The length of each thatch element can be customized to fit the particular use to which it is being applied. The remaining dimensions, i.e., width, thickness, circumference, diameter, or other appropriate dimension, can also be customized according to user preference. For example, thatch elements meant to mimic naturally-occurring grasses or palm leaves can take the form of elongate strips that are wider than they are thick.

The thatch elements according to the invention contain one or more texture elements, i.e., structures that provide texture to a surface of the thatch element, to give the thatch element a more natural appearance. The texture element can be regular, such as a raised ridge or an indentation that does not vary substantially along the length of the thatch element. The texture element may be in the form of raised ridges or indentations that mimic the venous structure of a natural leaf or grass. Alternatively, the texture element can be irregular, such as bumps, crevices, cracks, or pores that may be uniform or vary in size and number along the length of the thatch element. The texture can extend along the entire length of the thatch element, or it can extend over only a portion of the length. Any combination of regular and/or irregular texture elements can be present on a surface of a thatch element.

Preferred thatch elements have different textures on different surfaces of each thatch element. For example, in one embodiment, one surface of the thatch element contains one or more texture elements, while the other surfaces are comparatively non-textured. FIG. 1 illustrates a thatch element 1 that contains irregular texture elements in the form of bumps 4 on the top surface 2 of the thatch element 1. FIGS. 2a and 2b illustrate a thatch element 1 with a regular texture element in the form of a raised ridge 5 on the top surface 2 of the thatch element 1.

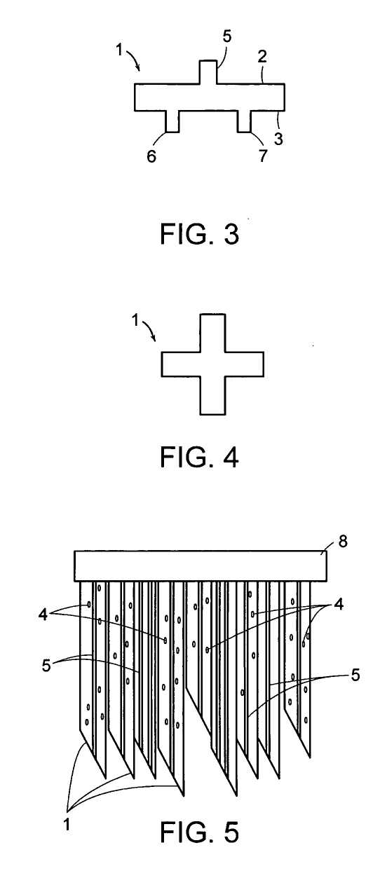

In other embodiments, both sides of the thatch element are textured. Preferred embodiments include thatch elements where the texture of one surface differs from the texture of the other surface. For example, the first surface may contain irregular texture elements, such as bumps or pores, while the second surface contains regular texture elements, such as one or more ridges. Alternatively, the first surface may contain a combination of regular and irregular texture elements, while the second surface contains regular and/or irregular texture elements. In another alternative, the first surface and the second surface may both contain regular texture elements, but the texture elements on each surface differ in number and/or shape. FIG. 3 illustrates such a thatch element 1, where the top surface 2 contains a regular texture element in the form of a raised ridge 5, and the bottom surface 3 contains two raised ridges 6 and 7 as texture elements. Other embodiments of thatch elements contain regular and irregular texture elements on both the first and second surfaces, and the regular texture elements on each surface may differ in number and/or shape.

The thatch elements can contain a natural-appearing color variegation, or a mix of two or more solid colors to create color blends, hues, and color highlights. Colors can be chosen to replicate natural flora or any other color pattern. The color variegation can be within an individual thatch element and/or between different thatch elements forming a thatch element construction, which provides for a range of colors that are derived from the individual dyes and/or pigments contained in the thatch composition.

Multiple thatch elements can be assembled into a thatch element construction. One embodiment of a thatch element construction is illustrated in FIG. 5, where multiple thatch elements 1, each containing irregular texture elements 4 and regular texture elements 5, are held together by a binder 8 to form a thatch panel or shingle. The thatch element constructions made using the thatch elements of the present invention have a more natural appearance than prior art thatch element constructions. Examples of thatch element constructions include, but are not limited to, panels for walls or awnings and roof shingles.

Methods of Making a Synthetic Textured Thatch Element

Thatch elements according to the present invention can be made by any method of polymer fabrication known in the art. Preferred methods include molding and extrusion processes.

Molded thatch elements can be prepared by compression or injection molding. In compression molding, a polymer and any additives are placed into a mold which is subsequently closed and typically maintained at a high pressure. In contrast, injection molding involves injecting a molten polymer into a closed mold. The molten polymer cools and hardens into the thatch element shape within the mold, which is then opened to remove the product. Any materials and methods used in compression or injection molding known in the art may be used to form the thatch elements.

The thatch elements are preferably made by an extrusion process. The extrusion process involves adding a solid polymer, along with any other additives discussed above, into a heated extruder. The components are transported through the extruder, for example, using a screw, toward a die affixed to the end of the barrel which is cut in the shape of the desired product. As the polymer moves within the extruder, the polymer begins to melt into a softer flowing material which mixes with the other additives. The molten polymer mixture is forced through the die, yielding a polymer extrudate. Additional finishing steps, such as threading the polymer extrudate into a quench bath to cool the polymer, removing excess water using an air blower, and/or threading the polymer extrudate through pinch rolls to control its width or diameter, can also be included in the process.

In some embodiments, after the extrusion process, the polymer extrudate is fed from the extruder into a cutter which cuts the polymer extrudate into individual thatch elements of the correct length and shape for the end user. For example, the extrudate can be cut at any angle relative to its longitudinal axis to provide individual thatch elements containing one or more ends that taper to a point.

In other embodiments, the polymer extrudate is packaged, for example, on a spool, and is cut into individual thatch elements at a later time. That is, the extrudate can be fed from a spool or container and cut during the process of forming a thatch element construction, such as a roof or wall panel. Optionally, the extrudate can be twisted prior to forming the thatch element construction. A creeling process, such as that used in textile manufacture or weaving, can also be used to form a thatch element construction from multiple extrudates.

Texture can be added to one or more sides of the thatch element by a number of methods, including, but not limited to, adding a blowing agent to the polymer, adding fillers to the polymer, extruding through a die that is formed in the shape of the texture element, molding where the texture is provided by the mold, extruding to create melt fracture at the die, embossing, chemical etching, and physical abrading techniques, such as sand blasting.

Blowing agents can be used to add texture to thatch elements made by either extrusion or molding methods. A blowing agent is a solid or a fluid that causes bubbles, for example, gas bubbles, to form within the polymer, which expand as the molten polymer cools. This process creates a foamed polymer structure, which is more lightweight and less dense than non-foamed polymers. The bubbles that reach the surface of the polymer create small bumps, crevices, and pores that impart a natural, grainy texture to the resulting thatch element. Examples of blowing agents include foaming agents such as Foamazol® 72 and Foamazol® XO-227 (Bergen International, Rochelle Park, N.J.). Gaseous blowing agents include gases such as nitrogen, carbon dioxide, and argon.

In one embodiment, a thatch element is formed by combining a polymer and a chemical blowing agent, along with any other additives, in an extruder, where they are melted and mixed. After the hot polymer extrudate exits the die, it is cooled to solidify the polymer. Cooling generally takes place in air and/or a water bath. By varying the rate at which the polymer extrudate cools, the degree of foaming and surface texture formation of the resulting thatch element can be controlled. The cooling rate can be controlled, for example, by adjusting the gap between the die and the water bath, or adjusting the temperature of the water in the bath.

In certain embodiments, one side of a foamed polymer extrudate is cooled preferentially over the other side while the gas bubbles are still expanding. This procedure creates differential texture formation on one surface of the thatch element compared to the other surface. When these thatch elements are assembled into a thatch element construction such as a thatch roof, random assembly produces some elements with the textured surface showing while others have the non-textured surface showing. This leads to thatch element constructions with more variation between thatch elements and a more natural appearance in the final construction.

In yet other embodiments, a textured thatch element is produced from a foamed polymer to which no blowing agent was added. This procedure involves carefully overheating the polymer to initiate degradation, which forms gas voids in the polymer. As with the gas bubbles produced by blowing agent additives, these voids expand as the molten polymer cools, and the voids that reach the surface of the polymer create small bumps, crevices, and pores that impart a natural texture to the resulting thatch element.

Another method for introducing texture to one or more surfaces of the thatch element is to add one or more fillers to the polymer. Suitable fillers include, for example, inorganic particles, minerals, clay, glass particles, polymeric particles, sand, metal filaments, and polymeric filaments. Fillers can be added to the polymer in its molten state prior to forming the thatch element, resulting in a thatch element with more than one textured surface. Alternatively, fillers can be added after the thatch element has formed, but before it has completely cooled and solidified. In this manner, texture can be introduced selectively on one or more surfaces of the thatch element.

Regular texture elements, such as raised ridges or indentations, can be added to one or more surfaces of a thatch element by extruding a molten polymer through a die that has the shape of the texture element cut into it. Molding processes also can produce thatch elements with similar regular texture elements and/or irregular texture elements, such as bumps, crevices, cracks, or pores, by building the texture elements into the mold.

It should be understood that two or more of the methods or steps for creating texture can be combined in a single process or performed in a stepwise manner to form a textured thatch element.

A thatch element can be colored by addition of colorants, dyes or pigments. In one embodiment, the color is variegated by sequential addition of more than one colorant to the extrusion or molding process. For example, a brown colorant may be added for a period of time and then stopped, with a green colorant then added for a period of time. The time cycle for the addition of each colorant can be controlled to produce different variegation effects. Mixing of the colorants within the extruder or molding machine can yield intermittent colors that transition from brown to green. The cycles of colorants can be repeated, and if the cycles are rapid, the resultant colors may never achieve the full brown or green. This variegation process can produce a more natural coloration within an individual thatch element as well as between thatch elements.

One exemplary method for adding color variegation to a thatch element involves attaching two or more color feeders, each of which containing a different colorant, to an extruder feed port. Any brand of color feeder may be used if the speed of the feeder can be controlled and adjusted. The color feeders are wired into a timer control box that also can be adjusted. Color variegation is achieved by running one color feeder at a time to deliver one colorant for a predetermined duration, after which time the timer stops the first feeder and starts a second feeder for a predetermined duration. The second color may chase, but does not catch, the first color. As the second color starts to exit the extruder, it cleans out the previous color, giving streaks, hues, and blends before the full second color exits. The process can be repeated with any number of colors fed into the extruder by different color feeders. The timer continues turning on and off the color feeders as programmed, and the color continues to change in this repeatable cycle. The resulting extrudate may have portions that are one color, and other portions that are a mixture of colors. Alternatively, the extrudate may only contain mixtures of colors.

It should be understood that in any of the methods described above and claimed herein, the steps can be performed in any order, or one or more steps can be performed simultaneously, as long as the method remains operable.

### EXAMPLES

The following examples are meant to illustrate, not limit, the scope of the present invention.

In each of the following examples, all ingredients were fed into a 2.5 inch Welex single screw extruder equipped with a 24:1 rigid PVC type screw. The extruder was separated into five thermally discreet zones, Zone 1, Zone 2, Zone 3, Zone 4, and Zone 5. In addition, the die was heated and held at a constant temperature during extrusion.

As the molten thatch extrudate exited the extruder, it was quenched in a ten foot long water bath equipped with two chambers or temperature zones. The quench stopped the extrudate from expanding and stiffened the extrudate so it could be conveyed forward for collection. The water bath could be moved closer or farther from the die to aid in diameter control and texture control. The first two feet of the bath (first chamber) contained water heated to 160° F. The remaining eight feet of the bath (second chamber) contained cold water to set the material straight. Quench rollers were adjustable for different thatch extrudate immersion depths and lengths in the bath chambers. The extrudate traveled over and under the adjustable rollers. The thatch extrudates were collected at 214 feet per minute and were then cut into discrete thatch elements about 18-20 inches in length with a rotating knife blade cutter.

### Example 1

A non-textured thatch element was prepared to use as a control against which textured thatch elements according to the invention were compared.

100 weight percent polyvinyl chloride (PVC) (PolyOne Geon® Compound 87416 pellet, PolyOne Corporation, Cleveland, Ohio) was added at a rate of 180 pounds per hour (lb/hr) to a 2.5 inch Welex single screw extruder equipped with a 24:1 rigid PVC type screw. The extruder was heated with the following temperature profile: Zone 1 at 355° F.; Zone 2 at 360° F.; Zone 3 at 360° F.; Zone 4 at 360° F.; Zone 5 at 365° F.; and the die 7 at 370° F. The polymer was extruded at a linear rate of 214 feet per minute (ft/min). The quench bath was set 16 inches from the die and the entire thatch element extrudate was immersed in the first two-foot section of the bath. The extrudate was then immersed in the remaining cold section to freeze in the structure and make the element straight.

The resulting thatch elements had non-textured, smooth top and bottom surfaces.

### Example 2

A thatch element with textured top and bottom surfaces was prepared using the following method.

99.5 weight percent PVC (PolyOne Geon® Compound 87416 pellet, PolyOne Corporation, Cleveland, Ohio) and 0.5 weight percent PVC foaming agent (Foamazol® XO-227, Bergen International, Rochelle Park, N.J.) were added at a rate of 140 lb/hr to a 2.5 inch Welex single screw extruder equipped with a 24:1 rigid PVC type screw. The extruder was heated with the following temperature profile: Zone 1 at 355° F.; Zone 2 at 360° F.; Zone 3 at 360° F.; Zone 4 at 360° F.; Zone 5 at 365° F.; and the die 7 at 370° F. The polymer was extruded at a linear rate of 214 ft/min. The quench bath was set 16 inches from the die and the entire polymer extrudate was immersed in the first two-foot section of the bath. The polymer extrudate was then immersed in the remaining cold section to freeze in the structure and make the element straight.

The resulting thatch elements had about 0.1 to about 1.5 mm high bumps on both the top and bottom surfaces, giving the thatch element a grainy, natural-appearing texture.

### Example 3

A thatch element with a textured top surface and a non-textured bottom surface was prepared using the following method.

99.0 weight percent PVC (Polyone Geon Compound 87416 pellet, Polyone Corporation, Cleveland, Ohio) and 1.0 weight percent PVC foaming agent (Foamazol® XO-227, Bergen International, Rochelle Park, N.J.) were added at a rate of 140 lb/hr to a 2.5 inch Welex single screw extruder equipped with a 24:1 rigid PVC type screw. The extruder was heated with the following temperature profile: Zone 1 at 355° F.; Zone 2 at 360° F.; Zone 3 at 360° F.; Zone 4 at 360° F.; Zone 5 at 365° F.; and the die 7 at 370° F. The polymer was extruded at a linear rate of 214 ft/min. Only the bottom of the polymer extrudate was contacted with the first two feet of quench water, instead of immersing the entire polymer extrudate under water. The entire polymer extrudate was then immersed in the remaining cold section to freeze in the structure and make the element straight.

The resulting thatch elements had about 0.1 to about 1.5 mm high bumps on the top surface, while the bottom surface was non-textured.

The invention may be embodied in other specific forms without departing form the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

1. A thatch element for building construction comprising:
an elongate polymer strip comprising a first surface and a second surface,
wherein at least one of the first surface and the second surface comprises a texture element.

2. The thatch element of claim 1, wherein the texture element is an irregular texture element.

3. The thatch element of claim 1, wherein the texture element is a regular texture element.

4. The thatch element of claim 1, wherein the polymer strip comprises a first end and a second end, the first end tapering to a point.

5. The thatch element of claim 1, wherein the polymer strip comprises a foamed polymer.

6. The thatch element of claim 1, comprising a particulate filler.

7. The thatch element of claim 1, comprising a second polymer.

8. The thatch element of claim 1, wherein at least one of the first surface and the second surface is embossed.

9. The thatch element of claim 1, wherein at least one of the first surface and the second surface is abraded.

10. A method of producing a thatch element for building construction, the method comprising the steps of:
forming a molten polymer into an elongate polymer strip comprising a first surface and a second surface; and
texturizing at least one of the first surface and the second surface.

11. The method according to claim 10, comprising foaming the polymer.

12. The method according to claim 10, wherein the texturizing step comprises embossing the polymer.

13. The method according to claim 10, wherein the texturizing step comprises abrading the polymer.

14. The method according to claim 10, wherein the forming step comprises extruding the polymer.

15. The method according to claim 10, wherein the forming step comprises molding the polymer.

16. The method according to claim 10, comprising the step of cutting the polymer strip to create at least one tapered end.

17. A method of producing a thatch element for building construction, the thatch element comprising an elongate polymer strip comprising a first surface and a second surface, wherein at least one of the first surface and the second surface comprises a texture element, the method comprising the steps of:
adding a blowing agent to a molten polymer; and
forming the molten polymer into an elongate polymer strip.

18. The method according to claim 17, wherein the blowing agent comprises a chemical foaming agent.

19. The method according to claim 17, wherein the blowing agent comprises a gas.

20. The method according to claim 17, wherein the forming step comprises extruding the polymer.

21. The method according to claim 17, wherein the forming step comprises molding the polymer.

22. The method according to claim 17, comprising the step of cutting the polymer strip to create at least one tapered end.
